(19) United States
(12) Patent Application Publication
(10) Pub. No.: US 2007/0035615 A1
(43) Pub. Date: Feb. 15, 2007

(54) METHOD AND APPARATUS FOR ADJUSTING OUTPUT IMAGES

(76) Inventor: Hua-Chung Kung, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/306,214

(22) Filed: Dec. 20, 2005

(30) Foreign Application Priority Data
Aug. 15, 2005 (TW) 94127684

(51) Int. Cl. H04N 7/14; H04N 7/18

(52) U.S. Cl. 348/14.08; 348/143

(57) ABSTRACT

A method and an apparatus for adjusting output images are provided. In the method, a target area is selected from the original frame received by an image receiving device and an image capturing device is controlled to capture the image within the target area. Hence, users can change angles to view images within different target areas without rotating the lens of the video device. In addition, the image resolution is adjusted automatically according to the screen resolution of the image receiving device or the resolution corresponding to the network bandwidth. Therefore, the defects in the prior art that mechanical operation is easily damaged and the manufacturing cost is high are eliminated. The purpose of effectively enhancing image resolution is also achieved.

### CROSS-REFERENCE TO RELATED APPLICATION

This application claims the priority benefit of Taiwan application serial no. 94127684, filed on Aug. 15, 2005. All disclosure of the Taiwan application is incorporated herein by reference.

### BACKGROUND OF THE INVENTION

1. Field of Invention

The present invention relates to a video device and an image adjusting method thereof. More particularly, the present invention relates to a video device and an image adjusting method thereof, used in a video conference, which automatically adjusts the output image at the image capturing device.

2. Description of Related Art

With the prevalence of the network, the technologies used in the network are continuously developing and improving day by day. In addition to the basic functions, such as browsing webs, receiving and sending e-mails, the functions of transmitting multi-media files, such as photos, music and video through the network are further developed recently. Moreover, because of the increase of network bandwidth, the transmission speed of network has been improved significantly. Hence, a video conference system has been recently developed to transmit real-time video images. The users can talk with others only by using a video capturing device and a video receiving device to link to a remote host through the network. Thus, the cost can be saved, and an extremely convenient communication channel between people can be established.

FIG. 1 is a schematic view of a conventional video device. Referring to FIG. 1, the conventional video device captures an image through the video capturing device 110 and transmits the image to the video receiving device 120 through the network 130 for viewing. Since the resolution of the screen of the video receiving device 120 is far lower than that of the image captured by the video capturing device 110, the image displayed on the screen of the video receiving device 120 is distorted. For example, the resolution of the Charge-Coupled Device (CCD) video camera is 640*480 pixel, while the resolution of the video receiving device 120 is usually only 176*144 pixel. If a specific object on the screen of the video receiving device 120 is to be amplified, the frame will become more blurred due to the degradation of the resolution.

Furthermore, the position of the lens is adjusted by the rotating mechanism on the video capturing device during the video conference, so as to focus on different objects in the frame. Therefore, the conventional video device at least has the following drawbacks:

1. A rotary mechanism is designed to rotate the lens in order to focus on different objects, resulting in an increase of the manufacturing cost.

2. The electric power consumption rises significantly due to the use of the above rotating mechanism.

b 3. The mechanical failure is likely to happen due to the mechanical wear because the lens is rotated mechanically.

### SUMMARY OF THE INVENTION

Accordingly, the object of the present invention is to provide a method for adjusting an output image, in which a video capturing device is controlled to capture the image within the target area by selecting a target area from an original frame, and thereby the purpose of enhancing the image resolution of an object is achieved.

Another object of the invention is to provide a method for adjusting an output image, in which the resolution of the captured target area image is adjusted according to the resolution of the video receiving device and the resolution of the network bandwidth, and thereby the purpose of enhancing the resolution of the video image is achieved.

Still another object of the invention is to provide an apparatus for adjusting an output image, in which the video capturing device is controlled to capture an image within a target area by adding the function of selecting an target image to the video receiving device, and the image resolution is adjusted according to the resolution of the video receiving device, and thereby the purpose of enhancing the resolution of the video image is achieved.

The present invention provides a method for adjusting an output image, which is applicable to a video capturing device and a video receiving device; wherein the resolution of the video capturing device is higher than that of the video receiving device. The method includes the following steps: First, the video capturing device is utilized to capture a frame and the frame is output to the video receiving device. Next, the video receiving device is utilized to select a target area from the frame and a target area signal corresponding to the target area is sent back to the video capturing device. Then, the video capturing device is utilized to capture an image within the target area in the original frame as a target image according to the target area signal, and meanwhile the resolution of the target image is adjusted to the resolution of the video receiving device. Finally, the target image is output to the video receiving device and the target image is displayed on the screen of the video receiving device.

According to the method for adjusting an output image according to the embodiment of the invention, the target area moved to adjust the target image output from the video capturing device, and repeating the above step for continuously outputting the target image after being moved is further included.

According to the method for adjusting an output image of the embodiment of the invention, wherein in the step of utilizing the video capturing device to capture a frame, a wide angle lens is further used to enlarge the range of the frame captured by the video capturing device.

According to the method for adjusting an output image of the embodiment of the invention, the above target area signal includes a set of window coordinates and a window size.

According to the method for adjusting an output image of the embodiment of the invention, wherein the data is transmitted between the video capturing device and the video receiving device through the network.

The invention provides a method for adjusting an output image, which is applicable to a video capturing device and a video receiving device, wherein the resolution of the video capturing device is higher than that of the video receiving device. The method comprises the following steps: First, the video capturing device is utilized to capture a frame and the frame is output to the video receiving device through the network. Next, the video receiving device is utilized to select a target area from the frame and a target area signal corresponding to the target area is sent back to the video capturing device through the network. Then, the video capturing device is utilized to capture an image within the target area in the original frame as a target image according to the target area signal, and adjust the resolution of the target image to the resolution of the corresponding network bandwidth, wherein the resolution of the network bandwidth is lower than that of the video receiving device. Finally, the target image is output to the video receiving device and displaying it on the screen of the video receiving device.

The invention provides an apparatus for adjusting an output image. The apparatus includes a video capturing device and a video receiving device. Wherein, the video capturing device is used for capturing a frame, and an image within a target area in a frame is captured as a target image according to a target area signal. Meanwhile, the resolution of the target image is adjusted to the resolution of the video receiving device. The video receiving device is used for receiving a frame, wherein a target area is selected from the frame, a target area signal corresponding to the target area is sent back to the video capturing device, and the target image sent back from the video capturing device is received.

According to the apparatus of adjusting an output image of the embodiment of the invention, the above video capturing device further includes a wide angle lens to enlarge the range of the frame captured by the video capturing device.

According to the apparatus of adjusting an output image of the embodiment of the invention, the above video capturing device further includes a regional image output device for determining the position and size of the target image, and meanwhile adjusting the resolution of the target image to the resolution of the video receiving device.

According to the apparatus of adjusting an output image of the embodiment of the invention, the video receiving device further includes a target area select device for providing a window for selecting a target area from the frame and transmitting a target area signal corresponding to the target area to the video capturing device.

According to the apparatus of adjusting an output image of the embodiment of the invention, the above window includes an auto-moving mode to move the selected target area automatically.

According to the apparatus of adjusting an output image of the embodiment of the invention, the target area described above includes a window coordinates and a window size.

According to the apparatus of adjusting an output image of the embodiment of the invention, the data is transmitted between the video capturing device and the video receiving device through the network.

The invention employs a structure having the function of selecting a target image in the video receiving device, so that the video capturing device is controlled to capture the image within the target area and adjust the resolution of the captured image automatically, and thereby the purpose of enhancing the resolution of the video image is achieved.

In order to the make the aforementioned and other objects, features and advantages of the present invention comprehensible, an embodiment accompanied with figures is described in detail below.

### BRIEF DESCRIPTION OF THE DRAWINGS

FIG. 1 is a schematic view of the conventional video device;

FIG. 2 is a block diagram of the apparatus for adjusting an output image according to the embodiment of the invention;

FIG. 3 is a schematic view of adjusting an output image according to the embodiment of the invention;

FIG. 4 is the flow chart of the method for adjusting an output image according to the embodiment of the invention; and

FIG. 5 is the flow chart of the method for adjusting an output image according to another embodiment of the invention.

### DESCRIPTION OF EMBODIMENTS

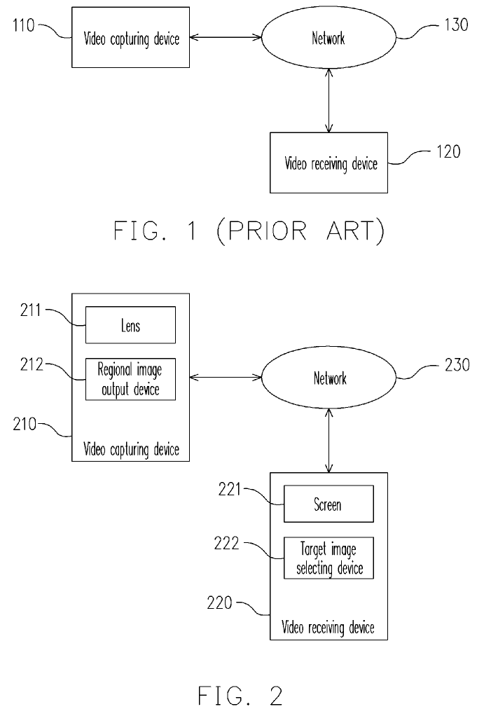

FIG. 2 is a block diagram of the apparatus for adjusting an output image according to the embodiment of the invention. Referring to FIG. 2, in the embodiment, a regional image output device 212 is added to the video capturing device 210, and a target image selecting device 222 is added to the video receiving device 220, so that the video capturing device 210 is controlled to capture an image within the specific area and adjust the resolution of the image to the resolution of the video receiving device 220. Therefore, the resolution of the selected regional image is enhanced.

As shown in FIG. 2, in the embodiment, the video capturing device 210 includes a set of lenses 211 and a regional image output device 212. The video receiving device 220 includes a screen 221 and a target image selecting device 222. The video capturing device 210 and the video receiving device 220 are linked through the network 230.

When the video receiving device 220 is connected with the video capturing device 210 through the network 230, the users can view the original image captured by the lens 211 of the video capturing device 210 on the screen 221 of the video receiving device 220. At this time, the users can move the window, provided by the target image selecting device 222, on the screen 221 to select a target area on the screen 221. Corresponding to the target area, a target area signal is sent back to the video capturing device 210. The target area signal may include the information about a set of window coordinates and window size, but not limit to this.

When the video capturing device 210 receives the target image signal, the target image signal is sent to the regional image output device 212, which determines the position and size of the target image according to the target image signal. After that, an image within the target area is captured as a target image and the resolution of the target image is adjusted to the resolution of the screen 221 of the video receiving device 220.

After the resolution has been adjusted, the regional image output device 212 of the video capturing device 210 sends the target image back to the video receiving device 220 through the network 230 and the target image is displayed on the screen 221. At this time, the image viewed by the users is converted from the original image into the regional image, achieving the same effect as that of the lens 211 after being rotated a certain angle. The users even can set the mode of the window provided by the target image selecting device 222 to the auto-moving mode to move the selected target area automatically, and thereby the view angle of the video frame is changed continuously to simulate the effect of the automatic monitor.

Moreover, the users may install a wide angle lens on the video capturing device 210 to enlarge the range of the captured original frame, so that the area to be selected is further enlarged. Therefore, the function of the apparatus of the invention becomes more powerful.

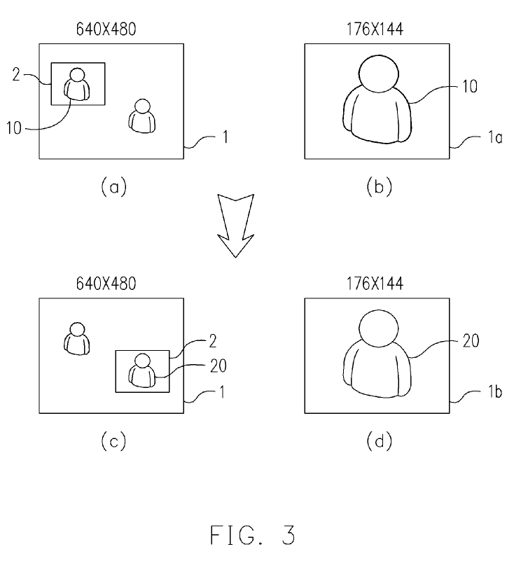

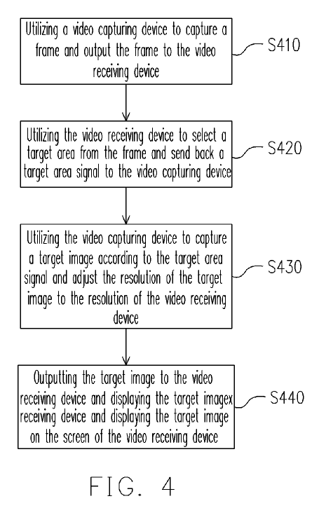

FIG. 3 is a schematic view of adjusting an output image according to the embodiment of the invention. Referring to FIG. 3, the original image 1 transmitted by the video capturing device is displayed on the screen of the video receiving device (as shown in FIG. 3(a)) firstly. Then, the user adjusts window 2 to the area near person 10 and presses the confirm button. Now, the video capturing device sends out the regional image selected by window 2 continuously, so that the user can view the regional image 1 a centered person 10 on the screen of the video receiving device (as shown in FIG. 3(b)).

Similarly, if the user wants to view person 20, he can move window 2 to the areas surrounding person 20 after the screen of the video receiving device returned to the original image 1, (as shown in FIG. 3(c)), and then press the confirm button. The video capturing device, at this time, sends the regional image selected by window 2 continuously, so that the user can view the regional image 1b centered person 20 on the screen of the video receiving device (as shown in FIG. 3(d)). Therefore, the user can select the person desired to view without rotating the lens.

FIG. 4 is the flow chart of the method for adjusting an output image according to the embodiment of the invention. Referring to FIG. 4, the embodiment is suitable for a video capturing device and a video receiving device, wherein the resolution of the video capturing device is higher than that of the video receiving device.

First, the video capturing device is used to capture an original frame, output the original frame to the video receiving device through the network and display the original frame on the screen of the video receiving device (step S410). The original frame is the full-pixel image captured by the video capturing device, which is usually 640*480 pixel (using 640*480 pixel CCD).

Then, the video receiving device is used to select a target area from the original frame, and the target area signal corresponding to the target area is sent back to the video capturing device (step S420). The target area signal may include the information about a set of window coordinates and window size, but not limit to this.

Next, the video capturing device is used to capture an image within the target area in the original frame (such as 640*480 pixel) as a target image (such as 88*72 pixel) according to the target area signal, and the resolution of the target image is adjusted to the resolution (such as 176*144 pixel) of the video receiving device (step S430).

Finally, the video capturing device is used to output the target image to the video receiving device and display the target image on the screen (with the resolution of 176*144 pixel) of the video receiving device (step S440).

Similarly, the user can select a second target area from the original frame again and send a second target area signal. The video capturing device is then used to capture a second target image corresponding to the second target area signal and transmit the target image to the screen of the video receiving device for displaying. By repeating the foresaid steps, the view angle of the video frame can be continuously changed, so as to simulate the effect of rotating the lens.

The above target image signal can be selected either by the users or by the video receiving device automatically, such that an automatic scanning mode is formed. The function mentioned above can simulate the same effect of automatic monitoring as a common monitor does.

It should be noted that the user may install a wide angle lens on the video capturing device to enlarge the range of the original frame captured by the video capturing device, such that the area to be selected is further enlarged. Therefore, the function of the apparatus of the present invention becomes more powerful.

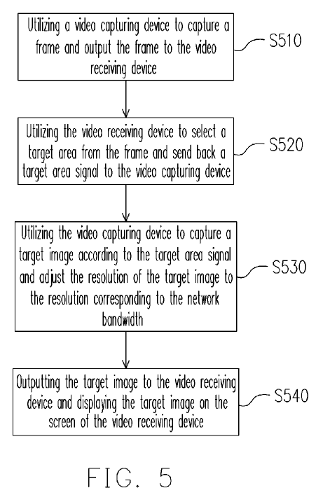

FIG. 5 is the flow chart of the method for adjusting an output image according to another embodiment of the invention. Referring to FIG. 5, the embodiment is suitable for a video capturing device and a video receiving device. The video capturing device and the video receiving device are linked through the network, wherein the resolution of the video capturing device is higher than that of the video receiving device, and the resolution of the video receiving device is higher than that corresponding to the network bandwidth.

First, the video capturing device is used to capture an original frame, output the original frame to the video receiving device through the network and display the original frame on the screen of the video receiving device (step S510).

Then, the video receiving device is used to select a target area from the original frame again and send back a target area signal corresponding to the target area to the video capturing device (step S520). Wherein, the target area signal may include the information about a set of window coordinates and window size, but not limit to this.

Next, the video capturing device is used to capture an image within the target area in the original frame (such as 640*480 pixel) as a target image (such as 64*48 pixel), and adjust the resolution of the target image to the resolution (such as 128*96 pixel) of the corresponding network bandwidth (step S530).

Finally, the video capturing device is used to output the target image to the video receiving device and display the target image on the screen (the resolution is 176*144 pixel) of the video receiving device (step S540).

To sum up, in the method and apparatus for adjusting an output image of the present invention, a target area is selected from the original frame received by an image receiving device and an image capturing device is controlled to capture the image within the target area, therefore, the user can change angles to view images in different target areas without rotating the lens of the video device. In addition, the resolution of the output image can be adjusted automatically according to the screen resolution of the image receiving device or the resolution corresponding to the network bandwidth. Therefore, the defects in the prior art that mechanical operation is easily damaged and the manufacturing cost is high are eliminated. The purpose of effectively enhancing image resolution is also achieved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for adjusting an output image, comprising:
utilizing a video capturing device to capture a frame and output the frame to a video receiving device;
utilizing the video receiving device to select a target area from the frame and send back a target area signal corresponding to the target area to the video capturing device;
utilizing the video capturing device to capture an image within the target area as a target image in the frame according to the target area signal, and adjust the resolution of the target image to the resolution of the video receiving device; and
outputting the target image to the video receiving device.

2. The method for adjusting an output image as claimed in claim 1, further comprising:
moving the target area to adjust the target image output from the video capturing device; and
repeating the above step for continuously outputting the target image after being moved.

3. The method for adjusting an output image as claimed in claim 1, wherein the step of utilizing the video capturing device to capture the frame further comprises using a wide angle lens to enlarge the range of the frame captured by the video capturing device.

4. The method for adjusting an output image as claimed in claim 1, wherein the target area signal comprises a set of window coordinates and a window size.

5. The method for adjusting an output image as claimed in claim 1, wherein the data is transmitted between the video capturing device and the video receiving device through a network.

6. A method for adjusting an output image, comprising:
utilizing a video capturing device to capture a frame and output the frame to a video receiving device through a network;
utilizing the video receiving device to select a target area from the frame and send back a target area signal corresponding to the target area to the video capturing device through a network;
utilizing the video capturing device to capture an image within the target area as a target image in the frame according to the target area signal, and adjust the resolution of the target image to the resolution of the corresponding network bandwidth; and
outputting the target image to the video receiving device.

7. The method for adjusting an output image as claimed in claim 6, further comprising:
moving the target area to adjust the target image output from the video capturing device; and
repeating the above step for continuously outputting the target image after being moved.

8. The method for adjusting an output image as claimed in claim 6, wherein the step of utilizing the video capturing device to capture the frame further comprises using a wide angle lens to enlarge the range of the frame captured by the video capturing device.

9. The method for adjusting an output image as claimed in claim 6, wherein the target area signal comprises a set of window coordinates and a window size.

10. An apparatus for adjusting an output image, comprising:
a video capturing device, for capturing a frame and capturing an image within a target area in the frame as a target image according a target area signal, and meanwhile adjusting the resolution of the target image to the resolution of the video receiving device; and
a video receiving device, for receiving the frame, selecting a target area from the frame, transmitting the target area signal corresponding to the target area to the video capturing device, and receiving the target image sent back from the video capturing device.

11. The apparatus for adjusting an output image as claimed in claim 10, wherein the video capturing device further comprises:
a wide angle lens, for enlarging the range of the frame captured by the video capturing device.

12. The apparatus for adjusting an output image as claimed in claim 10, wherein the video capturing device further comprises:
a regional image output device, for determining the position and size of the target image and adjusting the resolution of the target image to the resolution of the video receiving device.

13. The apparatus for adjusting an output image as claimed in claim 10, wherein the video receiving device further comprises:
a target area select device, for providing a window for selecting the target area from the frame and transmitting the target area signal corresponding to the target area to the video capturing device.

14. The apparatus for adjusting an output image as claimed in claim 13, wherein the window comprises an auto-moving mode to move the selected target area automatically.

15. The apparatus for adjusting an output image as claimed in claim 10, wherein the target area signal comprises a set of window coordinates and a window size.

16. The apparatus for adjusting an output image as claimed in claim 10, wherein the data is transmitted between the video capturing device and the video receiving device through a network.
